(19) United States
(12) Patent Application Publication
(10) Pub. No.: US 2026/0172618 A1
(43) Pub. Date: Jun. 18, 2026

(54) DEVICE AND METHOD FOR STREAMING VIDEO SEGMENTS RECEIVED FROM MEDIA SERVER

(71) Applicant: INDUSTRIAL COOPERATION FOUNDATION JEONBUK NATIONAL UNIVERSITY, Jeonju-si (KR)

(72) Inventor: Hyun Min NOH, Jeonju-si (KR)

(21) Appl. No.: 19/358,561

(22) Filed: Oct. 15, 2025

(30) Foreign Application Priority Data
Dec. 16, 2024 (KR) 10-2024-0186899
Jan. 23, 2025 (KR) 10-2025-0010136

(51) Int. Cl. H04N 21/2662; H04N 21/234; H04N 21/235

(52) U.S. Cl. CPC H04N 21/2662; H04N 21/23406; H04N 21/2353

(57) ABSTRACT

A method of streaming a number of video segments received from a media server is provided. The method includes determining image quality and upscaling parameters of a video segment of the number of video segments on the basis of metadata information of the video segment, requesting the video segment, storing the video segment received upon the request in a waiting buffer, upscaling the video segment stored in the waiting buffer based on the upscaling parameters, storing the upscaled video segment in a playback buffer, and playing back the video segment stored in the playback buffer. The metadata information includes quality information of the video segment, information on an upscaling model applicable to the video segment, and predictive information of quality improved by the upscaling model. The upscaling parameters include information about whether the upscaling is performed, and information on the upscaling model that performs the upscaling.

### CROSS REFERENCE TO RELATED APPLICATIONS

This application claims priority from and the benefit of Korean Patent Application No. 10-2024-0186899, filed on Dec. 16, 2024 and Korean Patent Application No. 10-2025-0010136, filed on Jan. 23, 2025, each of which is hereby incorporated by reference for all purposes as if fully set forth herein.

### BACKGROUND

### Field

Embodiments of the invention relate generally to a device and method for streaming video segments.

### Discussion of the Background

Adaptive streaming technology according to the related art aims to provide seamless streaming by dynamically adjusting video quality based on network conditions. However, this technology has some limitations.

First, when network conditions deteriorate rapidly, low-quality video segments are selected, which significantly degrades user experience. Particularly in environments with limited network bandwidth, it is difficult to stably provide high-resolution content.

Recently developed artificial intelligence (AI)-based super resolution (SR) technology provides the potential to convert low-quality content into high-resolution content, but it consumes excessive hardware resources, such as a graphics processing unit (GPU), significantly reducing energy efficiency. Also, images upscaled using the SR technology may show artifacts, which may lead to momentary quality degradation and lower perceived quality for users.

Existing dynamic adaptive streaming over hypertext transfer protocol (HTTP) (DASH) systems provide stable streaming through network-adaptive quality control, but the balance between energy consumption and user experience is not considered in a segment selection and quality control process. In particular, the trade-off between the energy consumption of a GPU and image quality is not effectively resolved, making it difficult to provide an optimal user experience.

In addition, according to the related art, interactions between a playback buffer and a waiting buffer are not effectively managed. When the playback buffer is depleted due to network conditions or declining hardware performance, there is a high likelihood of video stuttering (buffer underflow) because segments stored in an upscaling waiting buffer are not utilized in a timely manner. This problem may significantly degrade a user's streaming experience.

The above information disclosed in this Background section is only for understanding of the background of the inventive concepts, and, therefore, it may contain information that does not constitute prior art.

### SUMMARY

The inventive concepts are directed to providing a device and method for streaming video segments.

Additional features of the inventive concepts will be set forth in the description which follows, and in part will be apparent from the description, or may be learned by practice of the inventive concepts.

According to an aspect of the present invention, there is provided a method of streaming a number of video segments received from a media server. The method may include determining image quality and upscaling parameters of a video segment of the number of video segments on the basis of metadata information of the video segment, requesting the video segment, storing the video segment received upon the request in a waiting buffer, upscaling the video segment stored in the waiting buffer based on the upscaling parameters, storing the upscaled video segment in a playback buffer, and playing back the video segment stored in the playback buffer. The metadata information may include quality information of the video segment, information on an upscaling model applicable to the video segment, and predictive information of quality improved by the upscaling model. The upscaling parameters may include information about whether the upscaling is performed, and information on the upscaling model that may perform the upscaling.

The method may further include, when the upscaling is unnecessary on the basis of the upscaling parameters, transmitting the video segment stored in the waiting buffer to the playback buffer.

The determining of the image quality and the upscaling parameters may be performed on the basis of energy efficiency information required for the video segment, spatial quality information of the video segment, and difference information between the spatial quality information and spatial quality information of a video segment preceding the video segment.

The spatial quality information may include spatial quality information before the upscaling of the video segment, or spatial quality information after the upscaling of the video segment.

The energy efficiency information may be calculated on the basis of a video bit rate of the video segment and power consumption required for upscaling the video segment or basic power consumption.

The determining of the image quality and the upscaling parameters may be performed on the basis of spatial quality information of the video segment, the difference information between the spatial quality information and the spatial quality information of the video segment preceding the video segment, and an objective function defined using a weighted sum of energy efficiency information required for the video segment.

The determining of the image quality and the upscaling parameters may be performed on the basis of a comparison of a transmission lead time of the video segment and an available video segment playback time.

The transmission lead time may be calculated on the basis of a communication time with the media server, a size of the video segment, a network throughput of the media server, and an upscaling lead time for the video segment.

The available video segment playback time may be calculated on the basis of a total available video segment playback time and a marginal function of the playback buffer, and the total available video segment playback time may be calculated on the basis of a remaining playback time of the playback buffer, the number of video segments left in the waiting buffer, and a playback time of each video segment of the number of video segments.

An upscaling lead time for the video segment and the power consumption required for upscaling the video segment may be calculated on the basis of image quality of the video segment and the number of frames constituting the video segment.

The method may further include, when a remaining time of the playback buffer is a reference value or less, transmitting the number of video segments stored in the waiting buffer to the playback buffer.

The method may further include redetermining upscaling parameters of each of video segments stored in the playback buffer and the waiting buffer.

According to another aspect of the present invention, there is provided a computer program. The program may be stored in a recording medium to perform the method according to an exemplary embodiment of the inventive concepts.

According to another aspect of the present invention, there is provided a device for streaming a number of video segments received from a media server. The device may include a memory configured to store a program for streaming the number of video segments, and a processor configured to, by executing the program, determine image quality and upscaling parameters of a video segment of the number of video segments on the basis of metadata information of the video segment, request the video segment, store the video segment received upon the request in a waiting buffer, upscale the video segment stored in the waiting buffer based on the upscaling parameters, store the upscaled video segment in a playback buffer, and play back the video segment stored in the playback buffer. The metadata information may include quality information of the transmittable video segment, information on an upscaling model applicable to the video segment, and predictive information of quality improved by the upscaling model. The upscaling parameters may include information about whether the upscaling is performed, and information on the upscaling model that may perform the upscaling.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the inventive concepts.

FIG. 1 is a block diagram of a streaming system according to an exemplary embodiment of the inventive concepts;

FIG. 2 is a flowchart of a streaming method according to an exemplary embodiment of the inventive concepts;

FIG. 3 is a block diagram of a streaming device according to an exemplary embodiment of the inventive concepts; and

FIGS. 4(a), 4(b), 4(c), 4(d), and 4(e) are a set of graphs illustrating video segment streaming according to an exemplary embodiment of the inventive concepts.

### DETAILED DESCRIPTION

In the following description, for the purposes of explanation, numerous specific details are set forth in order to provide a thorough understanding of various embodiments or implementations of the invention. As used herein “embodiments” and “implementations” are interchangeable words that are non-limiting examples of devices or methods employing one or more of the inventive concepts disclosed herein. It is apparent, however, that various embodiments may be practiced without these specific details or with one or more equivalent arrangements. In other instances, well-known structures and devices are shown in block diagram form in order to avoid unnecessarily obscuring various embodiments. Further, various embodiments may be different, but do not have to be exclusive. For example, specific shapes, configurations, and characteristics of an embodiment may be used or implemented in another embodiment without departing from the inventive concepts.

Unless otherwise specified, the illustrated embodiments are to be understood as providing features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” may encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various embodiments are described herein with reference to sectional and/or exploded illustrations that are schematic illustrations of idealized embodiments and/or intermediate structures. As such, variations from the shapes of the illustrations as a result, for example, of manufacturing techniques and/or tolerances, are to be expected. Thus, embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some embodiments may be physically separated into two or more interacting and discrete blocks, units, and/or modules without departing from the scope of the inventive concepts. Further, the blocks, units, and/or modules of some embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

In describing the technical spirit of the inventive concepts, when detailed description of related known technology is determined to unnecessarily obscure the subject matter of the inventive concepts, the detailed description will be omitted.

The terms “unit,” “˜er,” “module,” “block,” etc., used herein mean a unit that processes at least one function or operation, and may be implemented as hardware, such as a processor, a microprocessor, a microcontroller, a central processing unit (CPU), a graphics processing unit (GPU), an accelerated processor unit (APU), a digital signal processor (DSP), an application specific integrated circuit (ASIC), a field programmable gate array (FPGA), etc., software, or a combination of hardware and software.

It is to be clarified that the distinction between components herein is merely a distinction by the primary function of each component. In particular, two or more components to be described below may be combined into one component or one component may be divided into two or more components on the basis of subdivided functions. Also, each component to be described below may additionally perform some or all of the functions that are handled by other components in addition to the primary function of the corresponding component, and some of the primary functions may be exclusively carried out by other components.

A method according to an embodiment of the inventive concepts may be performed by a personal computer (PC), a workstation, a server computer device, etc., with computing power or a separate device for the method.

In addition, the method may be performed by one or more computing devices. For example, at least one operation of the method according to an embodiment of the inventive concepts may be performed by a client device, and other operations may be performed by a server device. In this case, the client device and the server device may be connected via a network to transmit and receive computation results. Alternatively, the method may be performed using distributed computing technology.

Hereinafter, exemplary embodiments of the inventive concepts will be described in detail one after another.

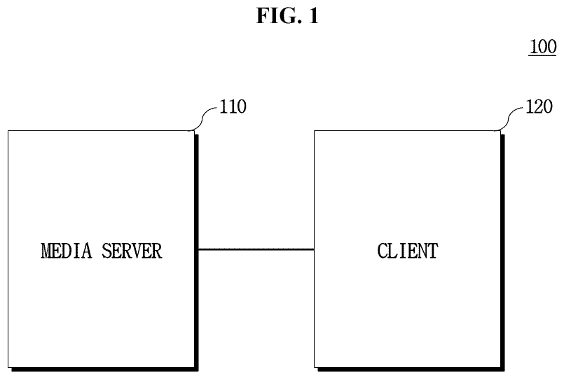

FIG. 1 is a block diagram of a streaming system according to an exemplary embodiment of the inventive concepts. Referring to FIG. 1, a streaming system 100 may include a media server 110 and a client 120. The media server 110 may divide video content into segments of a certain duration, store the video segments encoded at various quality levels, and provide the stored video segments upon request from the client 120. The media server 110 may communicate with the client 120 using, for example, the hypertext transfer protocol (HTTP) to stably and efficiently transmit data.

To this end, the media server 110 may provide metadata information to the client 120 such that the client 120 may select an appropriate upscaling model and quality level for network conditions, device performance, and the like.

The metadata information may be provided using, for example, a media presentation description (MPD) file. The MPD file is an extensible markup language (XML)-based manifest file containing information on streaming content, and may include, for example, location information of a video segment (e.g., a uniform resource locator (URL), etc.), time information (a start time and a duration), a language, the number of audio channels, media encoding information (a bit rate, a frame rate, a resolution, a codec type, etc.), network bandwidth requirements, buffering information, etc., such that the client 120 may download and play back a necessary video segment.

According to the exemplary embodiment, the MPD file may further include upscaling-related information. The upscaling-related information may include information on a time required for applying an upscaling model, upscaling model information, spatial quality information upon application of an upscaling model, required time information, power consumption information, and the like. However, the upscaling-related information is not limited thereto.

The upscaling model information may include, for example, fast super-resolution convolutional neural network (FSRCNN), enhanced super-resolution generative adversarial network (ESRGAN), basic video super-resolution (BASICVSR), or the like. The upscaling model may analyze relatively low-resolution video segments and convert the video segments into relatively high-resolution video segments. However, the upscaling model is not limited thereto.

The client 120 may receive video segments from the media server 110 and play back the received video segments. For example, the client 120 may be a dynamic adaptive streaming over HTTP (DASH) client. However, the client 120 is not limited thereto.

Specifically, the client 120 may request metadata information (or an MPD file) and parse the metadata information to check metadata such as a location of a video segment, a quality level, a bit rate, a duration, and the like.

The client 120 may determine image quality and upscaling parameters of the video segment to be played back on the basis of the metadata. Here, the image quality may be the resolution of the video segment but is not limited thereto. Also, the upscaling parameters may include information about whether upscaling is performed, and information on the upscaling model that may perform upscaling.

The client 120 may request the corresponding video segment on the basis of the image quality and the upscaling parameters of the video segment, receive the video segment, and then play back the received video segment after upscaling or without upscaling.

In addition, the client 120 may manage video segments stored in a waiting buffer and a playback buffer and redetermine upscaling parameters of a video segment stored in the waiting buffer.

FIG. 1 is illustrative, and various configurations are applicable depending on embodiments of the inventive concepts.

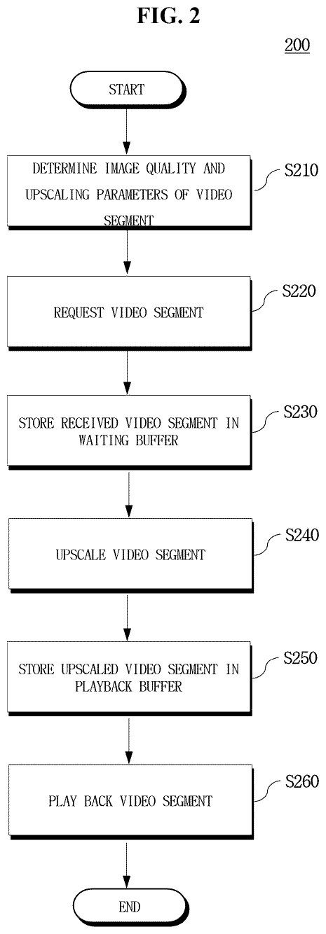

FIG. 2 is a flowchart of a streaming method according to an exemplary embodiment of the inventive concepts.

FIG. 2 relates to a method 200 of streaming video segments received from a media server, which may be performed by the client of FIG. 1 or the like.

First, in operation S210, image quality and upscaling parameters of a video segment to be played back may be determined on the basis of metadata information of the video segment. Here, the upscaling parameters may include information about whether upscaling is performed, and information on an upscaling model that may perform upscaling. Also, the image quality may be the resolution of the video segment. For example, the lowest image quality level may be set to a value of 1, and the value of an image quality level may increase with higher resolution. However, image quality levels are not limited thereto.

According to the exemplary embodiment, operation S210 may be performed on the basis of energy efficiency information required for the video segment, spatial quality information of the video segment, and difference information between the spatial quality information and spatial quality information of a video segment preceding the video segment.

Specifically, operation S210 may be performed on the basis of the spatial quality information of the video segment, the difference information between the spatial quality information and the spatial quality information of the video segment preceding the video segment, and a first objective function defined using a weighted sum of energy efficiency information required for the video segment.

Here, a weight applied to the first objective function may be a positive real number or a negative real number. For example, in the first objective function, the spatial quality information and energy efficiency information of the video segment may be a utility function, and the difference information between the spatial quality information and the spatial quality information of the video segment preceding the video segment may be a penalty function. However, the first objective function is not limited thereto.

According to the exemplary embodiment, the first objective function may be optimized such that a computation result of the first objective function (or a first objective function value) may be maximized. The first objective function may be optimized using, for example, a branch-and-bound technique. The optimization makes it possible to determine whether to perform optimal decision variable upscaling x, upscaling model m, and image quality q. However, the inventive concepts are not limited thereto.

According to the exemplary embodiment, the spatial quality information may be a peak signal-to-noise ratio (PSNR). However, the spatial quality information is not limited thereto.

According to the exemplary embodiment, the spatial quality information may include spatial quality information before upscaling of the video segment, or spatial quality information after upscaling of the video segment. The spatial quality information before and after upscaling may be generated by a media server and transmitted using the metadata information, but the spatial quality information is not limited thereto.

According to the exemplary embodiment, the energy efficiency information may be calculated on the basis of a video bit rate of the video segment and power consumption required for upscaling the video segment or basic power consumption. For example, the energy efficiency information may be calculated using a ratio of the video bit rate to power consumption for the video segment. Here, the power consumption for the video segment may be power consumption required for upscaling or basic power consumption required even without upscaling. Also, the power consumption or the basic power consumption may be power consumption of a GPU that performs upscaling. However, the power consumption or the basic power consumption is not limited thereto.

For example, the first objective function may be defined as expression 1.

$$α \cdot {QoE}_{i} ( {q}_{i} , {m}_{i} , {x}_{i} ) - β \cdot Δ QoE ( i , i - 1 ) + γ \cdot {e}_{i}^{eff} ( {q}_{i} , {m}_{i} , {x}_{i} ) \qquad [ Expression 1 ]$$

In expression 1, α, β, and γ are certain weights, which may be positive real numbers, and i is an index of a video segment which may be an integer of 1 or more. Also, qᵢ may indicate image quality of an i^{th} video segment, mᵢ may indicate information on an upscaling model used for the i^{th} video segment, and xᵢ may be a value of 0 or 1 indicating whether upscaling is performed on the i^{th} video segment. In addition, QoEᵢ(qᵢ, mᵢ, xᵢ) may indicate spatial quality information of the i^{th} video segment with image quality q, ΔQoEᵢ(i, i-1) indicates difference in spatial quality information between the i^{th} video segment and an (i-1)th video

$${e}_{i}^{eff} ( {q}_{i} , {m}_{i} , {x}_{i} )$$

may indicate information on energy efficiency required for the i^{th} segment, and video segment with image quality q.

For example, in the first objective function of expression 1, QoEᵢ may be defined as expression 2.

$${QoE}_{i} ( {q}_{i} , {m}_{i} , {x}_{i} ) = {x}_{i} \cdot {u}_{i}^{on} ( {q}_{i} , {m}_{i} ) + ( 1 - {x}_{i} ) \cdot {u}_{i}^{off} ( {q}_{i} ) \qquad [ Expression 2 ]$$

In expression 2,

$${u}_{i}^{on} ( {q}_{i} , {m}_{i} )$$

may indicate spatial quality information when upscaling model m is applied to the i^{th} video segment with image quality q, and

$${u}_{i}^{off} ( {q}_{i} )$$

may indicate spatial quality information when upscaling model m is not used for the i^{th} video segment with image quality q.

For example, in the first objective function of expression 1,

$${e}_{i}^{eff}$$

may be defined as expression 3.

$${e}_{i}^{eff} ( {q}_{i} , {m}_{i} , {x}_{i} ) = \frac{v ( {q}_{i} )}{{x}_{i} \cdot {e}^{up} ( {q}_{i} , {m}_{i} ) + ( 1 - {x}_{i} ) \cdot {e}_{base}} \qquad [ Expression 3 ]$$

In expression 3, v(qᵢ) may indicate a video bit rate of the i^{th} video segment with image quality q, e^{up}(qᵢ, mᵢ) may indicate power consumption required for applying upscaling model m to the i^{th} video segment with image quality q, and e_{base} may indicate basic power consumption, that is, power consumption when upscaling is not applied to the i^{th} video segment.

According to the exemplary embodiment, operation S210 may be performed on the basis of a comparison between a transmission lead time of the video segment and an available video segment playback time. The comparison of the transmission lead time and the playback time may be a first constraint of the first objective function. For example, the transmission lead time of the video segment is to be equal to or shorter than the available video segment playback time. However, the first constraint is not limited thereto.

According to the exemplary embodiment, the transmission lead time may be calculated on the basis of a communication time with the media server, a size of the video segment, a network throughput of the media server, and an upscaling lead time for the video segment.

For example, the transmission lead time may be calculated by adding a ratio of the size of the video segment to the network throughput of the media server, the communication time with the media server, and the upscaling lead time for the video segment. However, the transmission lead time is not limited thereto.

According to the exemplary embodiment, the available video segment playback time may be calculated on the basis of a total available video segment playback time and a marginal function of the playback buffer. For example, the available video segment playback time may be calculated on the basis of a product of the total available video segment playback time and the marginal function of the playback buffer. Also, the total available video segment playback time may be calculated on the basis of a remaining playback time of the playback buffer, the number of video segments left in the waiting buffer, and a playback time of each video segment.

For example, the first constraint may be defined as expression 4.

$${t}^{rtt} + \frac{{s}_{byte} ( {q}_{i} )}{tr} + {t}^{up} ( {q}_{i} , {m}_{i} ) \leq {t}_{avail}^{tot} \cdot {p}_{buf} ( {t}_{avail}^{tot} ) \qquad [ Expression 4 ]$$

In expression 4, t^{rtt} may indicate a round-trip time to the media server, tr may indicate a network throughput of the media server, S_{byte}(qᵢ) indicates a size (e.g., in unit of byte) of the i^{th} video segment with image quality q, and t^{up}(qᵢ, mᵢ) may indicate a time required for upscaling when upscaling model m is applied to the i^{th} video segment with image quality q.

Also,

$${t}_{avail}^{tot}$$

may indicate the total available video segment playback time, and

$${p}_{buf} ( {t}_{avail}^{tot} )$$

may indicate the marginal function of the playback buffer.

Here, the total available video segment playback time may be calculated on the basis of the remaining playback time of the playback buffer, the number of video segments left in the waiting buffer, and the playback time of each video segment.

For example, the total available video segment playback time may be defined as expression 5.

$${t}_{avail}^{tot} = {t}_{buf}^{play} + \vert {U}_{buf}^{wait} \vert \cdot {T}^{seg} \qquad [ Equation 5 ]$$

In expression 5,

$${t}_{buf}^{play}$$

may indicate a remaining playback time of the playback buffer,

$${t}_{buf}^{play}$$

may indicate a set of video segments in the waiting buffer, and T^{seg} may indicate a playback time of each video segment. A total playback time of video segments in the waiting buffer may be calculated using a product of a playback time of a set of video segments in the waiting buffer and a playback time of each video segment.

For example, the marginal function of the playback buffer may be defined as expression 6.

$${p}_{buf} ( {t}_{avail}^{tot} ) = {e}^{t ( {t}_{avail}^{tot} - {T}_{buf}^{max} )} \qquad [ Expression 6 ]$$

In expression 6, λ may indicate a buffer margin coefficient, and

$${T}_{buf}^{max}$$

may indicate a maximum playback time stored in a buffer. For example, the buffer margin coefficient may be a value between 0 and 1. The buffer margin coefficient may be closer to 0 with a smaller variation of the network throughput and may be closer to 1 with a larger variation of the network throughput. However, the buffer margin coefficient is not limited thereto.

According to the exemplary embodiment, the upscaling lead time for the video segment may be calculated on the basis of image quality of the video segment and the number of frames constituting the video segment. Additionally, the upscaling lead time for the video segment may be calculated on the basis of the performance of hardware that may perform upscaling.

According to the exemplary embodiment, the power consumption required for upscaling the video segment may be calculated on the basis of the image quality of the video segment and the number of frames constituting the video segment. Additionally, the power consumption required for upscaling the video segment may be calculated on the basis of the performance of hardware that may perform upscaling.

For example, the upscaling lead time for the video segment may be defined as expression 7.

$${t}^{up} ( {m}_{i} , {q}_{i} ) = {δ}_{{m}_{i} , g}^{up} \cdot {\{ {m}_{{q}_{i}} \times {h}_{{q}_{i}} \times {N}_{fps} \}}^{{v}_{m , g}^{up}} \qquad [ Expression 7 ]$$

In expression 7, gᵢ may indicate a GPU model used for upscaling the i^{th} video segment, w_{qi} and h_{qi} may indicate a width and height of resolution at image quality q of the i^{th} video segment, and N_{fps} may indicate the number of frames constituting the video segment. Also,

$${δ}_{{m}_{i} , g}^{up} and {v}_{m , g}^{up}$$

may indicate coefficients estimated in accordance with image quality m and GPU model g, respectively.

Also, for example, the power consumption required for upscaling the video segment may be defined as expression 8.

$${e}^{up} ( {m}_{i} , {q}_{i} ) = {ρ}_{{m}_{i} , g}^{up} \cdot {\{ {m}_{{q}_{i}} \times {h}_{{q}_{i}} \times {N}_{fps} \}}^{{μ}_{m , g}^{up}} \qquad [ Expression 8 ]$$

In expression 8,

$${ρ}_{{m}_{i} , g}^{up} and {μ}_{m , g}^{up}$$

may indicate coefficients that are estimated in accordance with image quality m and GPU model g, respectively.

Here,

$${δ}_{{m}_{i} , g}^{up} , {v}_{m , g}^{up} , {ρ}_{{m}_{i} , g}^{up} , and {μ}_{m , g}^{up}$$

may be acquired using, for example, the Levenberg-Marquardt method. However, the inventive concepts are not limited thereto.

In operation S220, the video segment of the determined image quality may be requested. The video segment may be composed of a plurality of video segments with different image quality, and in operation S220, the media server may be requested to transmit the video segment of the image quality determined in operation S210.

In operation S230, the video segment may be received from the media server in accordance with the request, and the received video segment may be stored in the waiting buffer. Here, the waiting buffer may be a memory region in which the video segment is stored before upscaling is performed. Specifically, the video segment stored in the waiting buffer may be converted based on an upscaling model or may be transmitted to the playback buffer without any changes when upscaling is unnecessary.

In operation S240, the video segment stored in the waiting buffer may be upscaled based on the upscaling parameters. Upscaling may be performed before the segment stored in the waiting buffer is transmitted to the playback buffer, and the video segment of relatively low image quality (i.e., resolution) may be converted into relatively high resolution through upscaling. Video segments stored in the waiting buffer may be sequentially upscaled in a first-in first-out manner. An upscaling model included in the upscaling parameters may be applied for upscaling, which may be performed by a general-purpose processor, a GPU for performing upscaling, or the like.

In operation S250, the upscaled video segment may be stored in a playback buffer. Here, the playback buffer may be a memory region in which a video segment that is being played back or waiting for a playback is stored.

In operation S260, the video segment stored in the playback buffer may be played back. Specifically, video segments stored in the playback buffer may be sequentially processed and provided to a user.

According to the exemplary embodiment, the method 200 may further include an operation of transmitting video segments stored in the waiting buffer to the playback buffer. The operation may be performed when upscaling is not performed on the video segments stored in the waiting buffer. For example, a video segment for which operation S240 is not performed on the basis of the upscaling parameters may be transmitted to the playback buffer. In particular, the video segment may be transmitted to the playback buffer without upscaling and played back. Also, for example, the operation may be performed when a residual time of the playback buffer is a reference value or less. In particular, when the residual time of the playback buffer is insufficient, video segments to be stored in the waiting buffer may be sequentially transmitted to the waiting buffer, maintaining a stable streaming environment.

According to the exemplary embodiment, the reference value may be set to a fixed value or a variable value depending on dynamic elements such as network conditions, a depletion rate of the playback buffer, and the like. For example, the reference value may be adjusted based on the network throughput or an expected transmission time in connection with metadata information provided by an MPD file. Also, the reference value may be optimized on the basis of user settings or device performance. However, the reference value is not limited thereto.

According to the exemplary embodiment, the method 200 may further include an operation of redetermining the upscaling parameters. The operation is intended to reevaluate and optimize the previously set upscaling parameters in consideration of dynamic states such as network conditions, the residual time of the playback buffer, etc., and may be performed on video segments stored in the playback buffer and the waiting buffer. For example, when there is a sufficient network bandwidth, a high-quality upscaling model may be selected, and when the network conditions deteriorate or there is a risk of the playback buffer running out, upscaling may be omitted or performed with a simple model. However, the inventive concepts are not limited thereto.

Specifically, the operation may be performed using a second objective function that is defined using the sum of computation results of the first objective function on a plurality of video segments. The plurality of video segments to which the first objective function is applied may include video segments that are stored in the playback buffer but are not played back, and video segments stored in the waiting buffer.

According to the exemplary embodiment, the second objective function may be optimized such that a computation result of the second objective function (or a second objective function value) may be maximized. The second objective function may be optimized through, for example, dynamic programming (DP). The optimization makes it possible to determine whether to perform optimal decision variable upscaling x, upscaling model m, and image quality q. However, the inventive concepts are not limited thereto.

For example, the second objective function may be defined as expression 9.

$${\sum }_{i = {s}_{pay}^{last} + 1}^{{s}_{rcv}^{last}} α \cdot {QoE}_{i} ( {q}_{i} , {m}_{i} , {x}_{i} ) - β \cdot Δ QoE ( i , i - 1 ) + γ \cdot {e}_{i}^{eff} ( {q}_{i} , {m}_{i} , {x}_{i} ) \qquad [ Expression 9 ]$$

In expression 9,

$${s}_{pay}^{last}$$

may indicate an index of a video segment that is lastly played back or currently being played back, and

$${s}_{rcv}^{last}$$

may indicate an index of a video segment that is lastly received from the media server.

For example, a second constraint may be defined as expressions 10 and 11.

$$[ Expression 10 ]$$

$${\sum }_{i = {s}_{play}^{last} + 1}^{k} {x}_{i} \cdot {t}^{up} ( {q}_{i} , {m}_{i} ) \leq {t}_{buf}^{play} + ( k - {s}_{play}^{last} - 1 ) \cdot {T}^{seg}$$

$$[ Expression 11 ]$$

$${s}_{play}^{last} \leq k \leq {s}_{rcv}^{last}$$

In expression 10, k may be a positive integer satisfying expression 11. The second constraint may be that expression 10 is to be satisfied for all k corresponding to expression 11.

FIG. 2 is illustrative, and various configurations are applicable in accordance with embodiments of the inventive concepts.

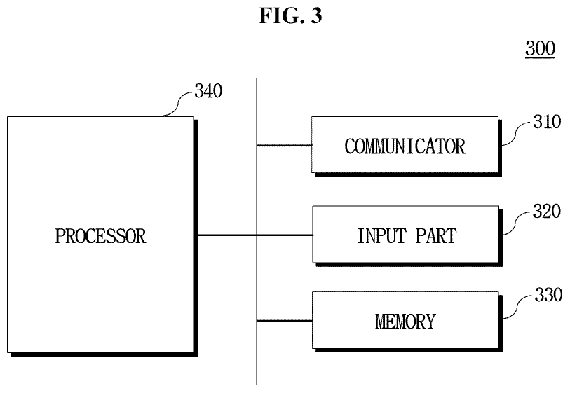

FIG. 3 is a block diagram of a streaming device according to an exemplary embodiment of the inventive concepts.

A streaming device 300 may be intended to perform the method 200 of FIG. 2 and may be referred to as the client 120 of FIG. 1, a DASH client, or the like.

Referring to FIG. 3, the streaming device 300 may include a communicator 310, an input part 320, a memory 330, and a processor 340.

The communicator 310 may receive or send data internally or externally. The communicator 310 may include wired and wireless communicators. When the communicator 310 includes the wired communicator, the communicator 310 may include one or more components that allows communication via a local area network (LAN), a wide area network (WAN), a value added network (VAN), a mobile radio network, a satellite network, and a combination thereof. Also, when the communicator 310 includes the wireless communicator, the communicator 310 may wirelessly transmit and receive data or signals using cellular communication, a wireless LAN (e.g., Wi-Fi), or the like. According to the exemplary embodiment, the communicator 310 may transmit and receive data or signals to and from an external device or external server under the control of the processor 340.

The input part 320 may receive various user instructions through external operations. To this end, the input part 320 may include one or more input devices or may be connected thereto. For example, the input part 320 may be connected to an interface for various inputs, such as a keypad, a mouse, or the like, to receive user instructions. To this end, the input part 320 may include not only a Universal Serial Bus (USB) port but also an interface such as Thunderbolt or the like. In addition, the input part 320 may include various input devices, such as a touchscreen, a button, etc., or may be coupled thereto to receive external user instructions.

The memory 330 may store a program and/or program instructions for the processor 340 to operate and temporarily or permanently store input/output data. Specifically, the memory 330 may store various data, programs (one or more instructions), applications, software, instructions, code, etc., for operating and controlling the processor 340. For example, the memory 330 may include at least one type of storage medium among a flash memory type memory, a hard disk type memory, a multimedia card micro type memory, a card type memory (e.g., a secure digital (SD) memory, an extreme digital (XD) memory, etc.), a random access memory (RAM), a read-only memory (ROM), an electrically erasable programmable ROM (EEPROM), a programmable ROM (PROM), a magnetic memory, a magnetic disk, and an optical disk.

According to the exemplary embodiment, the memory may include a waiting buffer and a playback buffer for storing video segments received from a media server. The waiting buffer may be a memory region in which video segments are stored before upscaling is performed. The playback buffer may be a memory region in which a video segment that is being played back or waiting for a playback is stored. For example, the playback buffer may store both an upscaled video segment and a non-upscaled video segment.

The processor 340 may control overall operations of the device 300. The processor 340 may execute one or more programs or software stored in the memory 330. The processor 340 may be a CPU, a GPU, or a dedicated processor for performing methods according to embodiments of the inventive concepts.

According to the exemplary embodiment, the processor 340 may determine image quality and upscaling parameters of a video segment on the basis of metadata information of the video segment, request the video segment of the determined image quality, store the video segment received upon the request in the waiting buffer, upscale the video segment stored in the waiting buffer in accordance with the upscaling parameters, store the upscaled video segment in the playback buffer, and play back the video segment stored in the playback buffer.

According to the exemplary embodiment, the processor 340 may transmit the video segment stored in the waiting buffer to the playback buffer when it is unnecessary to upscale the video segment on the basis of the upscaling parameters.

According to the exemplary embodiment, the processor 340 may transmit video segments stored in the waiting buffer to the playback buffer when a residual time of the playback buffer is a reference value or less.

According to the exemplary embodiment, the processor 340 may redetermine upscaling parameters of each of video segments stored in the playback buffer and the waiting buffer.

FIG. 3 is illustrative, and various configurations are applicable depending on embodiments of the inventive concepts.

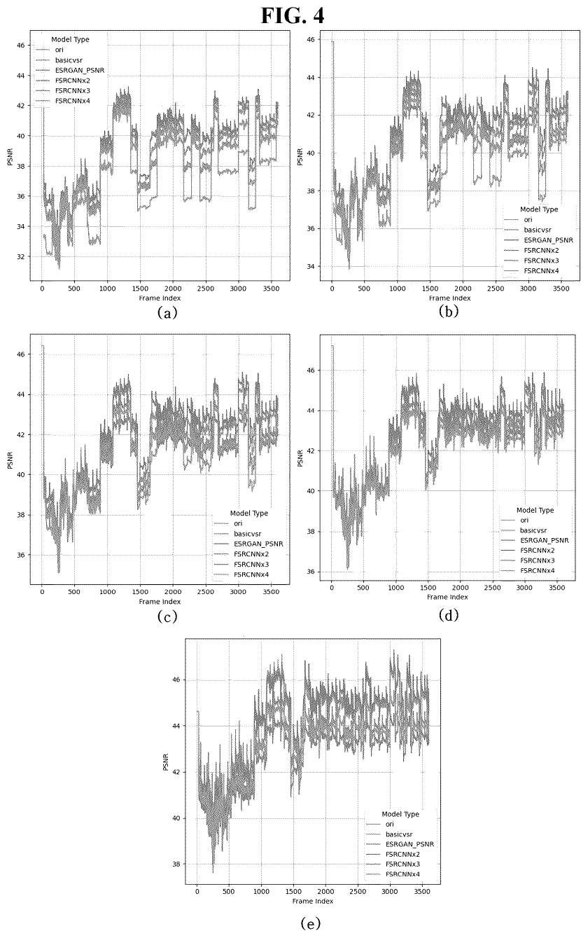

FIGS. 4(a)-(e) are a set of graphs illustrating video segment streaming according to an exemplary embodiment of the inventive concepts.

FIGS. 4(a)-(e) show spatial quality information of video segments in accordance with image quality (i.e., resolution) of the video segments and upscaling models applied to the video segments.

FIGS. 4(a)-(e) relate to video segments with resolution of 426×240, 640×360, 854×480, 1280×720, and 1920×1080, respectively. A horizontal axis of a graph may indicate frame indexes of the upscaling models applied to each video segment, and a vertical axis may indicate PSNRs as spatial quality information.

The graphs show performance for an original video segment without application of upscaling and video segments to which upscaling models (“basicvsr.” “enhanced super-resolution generative adversarial network (ESRGAN_PSNR),” FSRCNN×2,” “FSRCNN×3,” and “FSRCNN×4”) may be applied.

As shown in the drawing, an appropriate upscaling model and a spatial quality level provided by each upscaling model vary depending on resolution. In particular, even when upscaling may be performed, a change in spatial quality may be low or, in some cases, spatial quality actually deteriorates compared to the case where upscaling is not performed.

FIGS. 4(a)-(e) are illustrative, and various configurations are applicable depending on embodiments of the inventive concepts.

The method according to the embodiment of the inventive concepts may be implemented in the form of program instructions that are executable by various computing means, and recorded on a computer-readable recording medium. The computer-readable recording medium may include program instructions, data files, data structures, etc., solely or in combination. The program instructions recorded on the medium may be specially designed and structured for the inventive concepts or may be known and available to those skilled in the art of computer software. Examples of the computer-readable recording medium may include magnetic media such as a hard disk, a floppy disk, and magnetic tape, optical media such as a compact disc (CD)-ROM and a digital versatile disk (DVD), a magneto-optical media such as a floptical disk, and hardware devices specifically configured to store and execute program instructions such as a ROM, a RAM, a flash memory, and the like. Examples of program instructions include not only machine code such as that created by a compiler but also may include high-level language code that is executable by a computer using an interpreter or the like.

A method according to the disclosed embodiments may be included and provided in a computer program product. The computer program product may be tradable between sellers and buyers as goods.

The computer program product may include a software program and a computer-readable storage medium storing a software program. For example, the computer program product may include a product (e.g., a downloadable application) in the form of a software program that is electronically distributed through a manufacturer of an electronic device or an electronic market (e.g., Google PlayStore™ or AppStore™). For electronic distribution, at least a part of the software program may be stored in the storage medium or temporarily generated. In this case, the storage medium may be a storage medium of a server of a manufacturer, a server of an electronic market, or a relay server that temporarily stores the software program.

The computer program product may include a storage medium of a server or a storage medium of a client terminal in a system including the server and the client terminal. Alternatively, when there is a third device (e.g., a smartphone) that is communicatively connected to the server or the client device, the computer program product may include a storage medium of the third device. Alternatively, the computer program product may include a software program transmitted from the server to the client device or the third device or transmitted from the third device to the client device.

In this case, one of the server, the client device, and the third device may perform a method according to the disclosed embodiments by executing the computer program product. Alternatively, two or more of the server, the client device, and the third device may execute the computer program product to perform a method according to the disclosed embodiments in a distributed manner.

For example, a server (e.g., a cloud server or an artificial intelligence server) may execute the computer program product stored in the server to control the client device communicatively connected to the server to perform a method according to the disclosed embodiments.

According to exemplary embodiments of the inventive concepts, in a streaming system, particularly, in a DASH system, it is possible to play back high-quality images and efficiently manage resources in consideration of network conditions and limitations on device resources simultaneously.

According to exemplary embodiments of the inventive concepts, the structure of MPD files may be extended. Accordingly, a client may select an optimal segment, and it is possible to flexibly cope with changes of network conditions.

According to exemplary embodiments of the inventive concepts, a segment to be upscaled may be processed in a waiting buffer using an optimal model and then transmitted to a playback buffer. When network conditions deteriorate, upscaling may be omitted, and the segment may be immediately moved to the playback buffer, ensuring seamless playback.

According to exemplary embodiments of the inventive concepts, it is possible to provide high-resolution content by utilizing super resolution (SR) technology while minimizing energy consumption of a GPU.

According to exemplary embodiments of the inventive concepts, it is possible to implement a next-generation adaptive streaming solution that simultaneously considers changes of network conditions and device resource constraints to play back high-quality images and achieve energy efficiency, and provides excellent user experiences and stability compared to the related art.

Effects that may be achieved by exemplary embodiments of the inventive concepts are not limited to those described above, and other effects that have not been described will be clearly understood from the above description by those skilled in the technical field to which the inventive concepts pertains.

Although exemplary embodiments have been described in detail above, the scope of the inventive concepts are not limited thereto, and various modifications and improved forms made by those of ordinary skill in the art using the basic concept of the inventive concepts defined in the following claims also fall within the scope of the inventive concepts.

Although certain embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of streaming a number of video segments received from a media server, the method comprising:
determining image quality and upscaling parameters of a video segment of the number of video segments on the basis of metadata information of the video segment;
requesting the video segment;
storing the video segment received upon the request in a waiting buffer;
upscaling the video segment stored in the waiting buffer based on the upscaling parameters;
storing the upscaled video segment in a playback buffer; and
playing back the video segment stored in the playback buffer,
wherein the metadata information comprises quality information of the video segment, information on an upscaling model applicable to the video segment, and predictive information of quality improved by the upscaling model, and
wherein the upscaling parameters comprise information about whether the upscaling is performed, and information on the upscaling model that performs the upscaling.

2. The method of claim 1, further comprising, when the upscaling is unnecessary on the basis of the upscaling parameters, transmitting the video segment stored in the waiting buffer to the playback buffer.

3. The method of claim 1, wherein the determining of the image quality and the upscaling parameters is performed on the basis of energy efficiency information required for the video segment, spatial quality information of the video segment, and difference information between the spatial quality information and spatial quality information of a video segment preceding the video segment.

4. The method of claim 3, wherein the spatial quality information comprises spatial quality information before the upscaling of the video segment, or spatial quality information after the upscaling of the video segment.

5. The method of claim 3, wherein the energy efficiency information is calculated on the basis of a video bit rate of the video segment and power consumption required for upscaling the video segment or basic power consumption.

6. The method of claim 3, wherein the determining of the image quality and the upscaling parameters is performed on the basis of spatial quality information of the video segment, the difference information between the spatial quality information and the spatial quality information of the video segment preceding the video segment, and an objective function defined using a weighted sum of energy efficiency information required for the video segment.

7. The method of claim 3, wherein the determining of the image quality and the upscaling parameters is performed on the basis of a comparison of a transmission lead time of the video segment and an available video segment playback time.

8. The method of claim 7, wherein the transmission lead time is calculated on the basis of a communication time with the media server, a size of the video segment, a network throughput of the media server, and an upscaling lead time for the video segment.

9. The method of claim 7, wherein the available video segment playback time is calculated on the basis of a total available video segment playback time and a marginal function of the playback buffer, and
wherein the total available video segment playback time is calculated on the basis of a remaining playback time of the playback buffer, a number of video segments left in the waiting buffer, and a playback time of each of the number of video segments.

10. The method of claim 5, wherein an upscaling lead time for the video segment and the power consumption required for upscaling the video segment are each calculated on the basis of image quality of the video segment and a number of frames comprising the video segment.

11. The method of claim 1, further comprising, when a remaining time of the playback buffer is a reference value or less, transmitting video segments stored in the waiting buffer to the playback buffer.

12. The method of claim 1, further comprising redetermining upscaling parameters of each of the number of video segments stored in the playback buffer and the waiting buffer.

13. A computer program stored in a recording medium to perform the method according to claim 1.

14. A device for streaming a number of video segments received from a media server, the device comprising:
a memory configured to store a program for streaming the number of video segments; and
a processor configured to, by executing the program, determine image quality and upscaling parameters of a video segment of the number of video segments on the basis of metadata information of the video segment, request the video segment, store the video segment received upon the request in a waiting buffer, upscale the video segment stored in the waiting buffer based on the upscaling parameters, store the upscaled video segment in a playback buffer, and play back the video segment stored in the playback buffer,
wherein the metadata information comprises quality information of the video segment, information on an upscaling model applicable to the video segment, and predictive information of quality improved by the upscaling model, and
wherein the upscaling parameters comprise information about whether the upscaling is performed, and information on the upscaling model that performs the upscaling.
